(19) United States
(12) Patent Application Publication
(10) Pub. No.: US 2026/0072797 A1
(43) Pub. Date: Mar. 12, 2026

(54) HARDWARE RECOVERY UTILIZING STATE INFORMATION

(71) Applicant: MELLANOX TECHNOLOGIES, LTD., Yokneam (IL)

(72) Inventors: Itai Geffen, Tel Aviv (IL); Roni Bar Yanai, Even Yehuda (IL)

(21) Appl. No.: 18/828,724

(22) Filed: Sep. 9, 2024

(51) Int. Cl. G06F 11/14

(52) U.S. Cl. CPC G06F 11/1471; G06F 11/1433

(57) ABSTRACT

Embodiments of the present disclosure are directed to a zero-time hardware recovery process. The recovery process utilizes a persistent memory shared between applications and in which the applications write execution data and hardware state information. This memory can be a file, a network database, another network resource, etc. Generally speaking, a primary application creates and manages communication ports which are used as a communication channel to the hardware/firmware and which can be shared between the applications. The primary application also listens for process recovery attempts. A secondary application writes execution data and hardware state information to the persistent memory. Upon a recovery of the second process, the execution data and hardware state information is received from the shared persistent memory. The recovery can be performed in response to a crash or a version update.

### FIELD OF THE DISCLOSURE

The present disclosure is generally directed to a hardware recovery process and more particularly to a zero-time hardware recovery process utilizing hardware state information stored in a persistent memory.

### BACKGROUND

As an application process executes on a computing device, various hardware state information is set depending upon the state of the application. Upon a device or process recovery, for example due to a failure or an update, such information can be lost or, if recovered, may not reflect the latest system recovery state.

### BRIEF SUMMARY

Embodiments of the present disclosure are directed to a zero-time hardware recovery process. The recovery process utilizes a persistent memory shared between applications and in which the applications write execution data and hardware state information. This memory can be a file, a network database, another network resource, etc. Generally speaking, a primary application creates and manages communication ports which are used as a communication channel to the hardware/firmware and which can be shared between the applications. The primary application also listens for process recovery attempts. A secondary application writes execution data and hardware state information to the persistent memory. Upon a recovery of the second process, the execution data and hardware state information is received from the shared persistent memory. The recovery can be performed in response to a crash or a version update.

According to one embodiment, a computing device can comprise a control circuit controlling operation of the computing device. The control circuit can cause the computing device to execute a first process. The first process can create and manage communication ports to hardware of the computing device and listen for process recovery attempts. The control circuit can also cause the computing device to execute a second process. The second process can maintain system recovery state information in a persistent memory accessible by the first process and the second process. Upon a recovery of the second process, the second process can recover the system recovery state information from the persistent memory.

According to one aspect, the recovery of the second process can comprise a crash recovery.

According to one aspect, the recovery of the second process can comprise a version update recovery.

According to one aspect, maintaining the system recovery state information can comprise writing hardware state information to the persistent memory.

According to one aspect, the recovery of the second process can further comprise recovery of the hardware state information from the persistent memory.

According to one aspect, the persistent memory can comprise a superblock and the superblock can comprise metadata describing a memory structure for the system recovery state information.

According to one aspect, upon the recovery of the second process, the second process can issue an import request for a command channel to the first process.

According to one aspect, the first process can serve the import request from the second process and the second process can then use the command channel.

According to another embodiment, a system can comprise a communication network and a computing device coupled with the communication network. The computing device can comprise a control circuit controlling operation of the computing device. The control circuit can cause the computing device to execute a first process. The first process can create and manage communication ports to hardware of the computing device and listen for process recovery attempts. The control circuit can further cause the computing device to execute a second process. The second process can maintain system recovery state information in a persistent memory accessible to the first process and the second process and, upon a recovery of the second process, recover the system recovery state information from the persistent memory.

According to one aspect, the recovery of the second process can comprise a crash recovery.

According to one aspect, the recovery of the second process can comprise a version update recovery.

According to one aspect, maintaining the system recovery state information can comprise writing hardware state information to the persistent memory and wherein the recovery of the second process can further comprise recovery of the hardware state information from the persistent memory.

According to one aspect, the persistent memory can comprise a superblock and wherein the superblock can comprise metadata describing a memory structure for the system recovery state information.

According to one aspect, upon the recovery of the second process, the second process can issue an import request for a command channel to the first process, the first process can serve the import request from the second process, and the second process can then use the command channel.

According to one aspect, the second process can comprise a plurality of second processes and each of the plurality of second processes can maintain system recovery state information in the persistent memory and, upon recovery, recover the system recovery state information from the persistent memory.

According to yet another embodiment, a method for recovery of an execution process can comprise executing a first process. The first process can create and manage communication ports to hardware of the computing device and listen for process recovery attempts. A second process can also be executed. The second process can maintain system recovery state information in a persistent memory accessible by the first process and the second process and, upon a recovery of the second process, recover the system recovery state information from the persistent memory.

According to one aspect, the recovery of the second process can comprise a crash recovery.

According to one aspect, the recovery of the second process can comprise a version update recovery.

According to one aspect, maintaining the system recovery state information can comprise writing hardware state information to the persistent memory and the recovery of the second process can further comprise recovery of the hardware state information from the persistent memory.

According to one aspect, upon the recovery of the second process, the second process can issue an import request for a command channel to the first process, the first process can serve the import request from the second process, and the second process can then use the command channel.

### BRIEF DESCRIPTION OF THE SEVERAL VIEWS OF THE DRAWINGS

The present disclosure is described in conjunction with the appended figures, which are not necessarily drawn to scale.

FIG. 1 is a block diagram illustrating an exemplary environment in which embodiments of the present disclosure may be implemented.

FIG. 2 is a flowchart illustrating an exemplary process for performing zero-time hardware recovery according to one embodiment of the present disclosure.

FIG. 3 is a flowchart illustrating additional details of exemplary process for performing zero-time hardware recovery according to one embodiment of the present disclosure.

FIG. 4 is a flowchart illustrating additional details of exemplary process for performing zero-time hardware recovery according to one embodiment of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

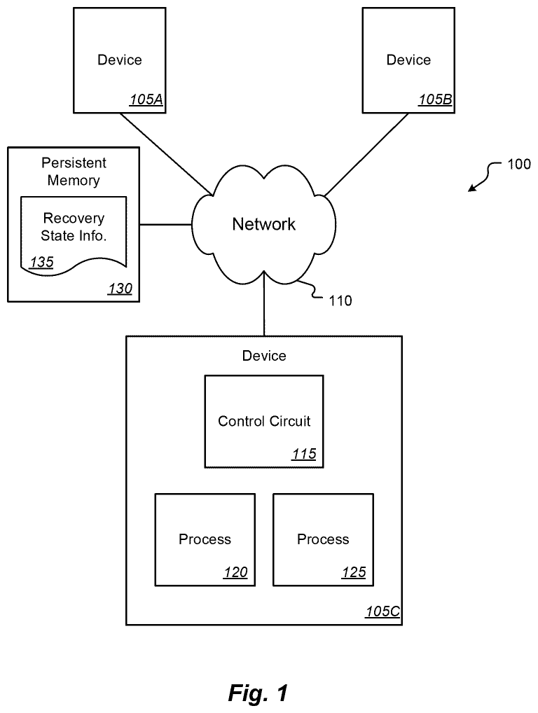

Referring now to FIGS. 1-4, various systems and methods for a zero-time hardware recovery process will be described. The recovery process utilizes a persistent memory shared between applications and in which the applications write execution data and hardware state information. This memory can be a file, a network database, another network resource, an internal dedicated HW capable of fast persistent memory sharing, etc. Generally speaking, a primary application creates and manages communication ports which are used as a communication channel to the hardware/firmware and which can be shared between the applications. The primary application also listens for process recovery attempts. A secondary application writes execution data and hardware state information to the persistent memory. Upon a recovery of the second process, the execution data and hardware state information is received from the shared persistent memory. The recovery can be performed in response to a crash or a version update.

FIG. 1 is a block diagram illustrating an exemplary environment in which embodiments of the present disclosure may be implemented. As illustrated in this example, the environment 100 can comprise any number of computing devices 105A-105C coupled with a communication network 110. Each computing device 105A-105C can comprise, for example, a server or a component thereof such as a Data Processing Unit (DPU), Graphics Processing Unit (GPU), Network Interface Card (NICs), or other computing device as known in the art. The communication network 110 can comprise any number of wired and/or wireless, local-area and/or wide-area networks as known in the art.

Each computing device 105A-105C can comprise a control circuit 115 controlling operation of the computing device 105C. The control circuit 115 can comprise a Central Processing Unit (CPU), e.g., one or more microprocessors, or similar components as known in the art. Generally speaking, the control circuit 115 can cause the device to perform a zero-time recovery process as described herein in response to a failure or an update of the computing device 105C.

More specifically, the control circuit 115 can cause the computing device to execute a first process 120. The first process 120 can create and manage communication ports to hardware of the computing device 105C and listen for process recovery attempts. The control circuit 115 can also cause the computing device to execute a second process 125. The second process 125 can maintain system recovery state information 135 in a persistent memory 130 accessible by the first process 120 and the second process 125. The persistent memory 130 can be a file, a network database, another network resource, etc. accessible by, i.e., shared by, the first and second processes 120 and 125 and other processes executing one the computing devices 105A-105C. The system recovery state information can comprise, for example, hardware state information for the computing device 105C. According to one embodiment, the persistent memory 130 can comprise a superblock. In such cases, the superblock can comprise metadata describing a memory structure for the system recovery state information 135.

Upon a recovery of the second process 125, the second process can recover the system recovery state information 135 from the persistent memory 130. The recovery of the second process can comprise a crash recovery or version update recovery. The recovery of the second process 125 can further comprise recovery of the hardware recovery state information 135 from the persistent memory 130. To do so, the second process 125 can issue an import request for a command channel, i.e., one of the communication ports created and managed by the first process 120, to the first process 120. The first process 120 can serve the import request from the second process 125 and the second process 125 can then use the command channel.

It should be noted that, in various implementations, the second process 125 can be one of many such processes executing on one or more of the computing devices 105A-105C in cases where the port is fully owned by only one second process. Similarly, the first process 120 can be one of many such processes executing on one or more of the computing devices 105A-105C. In one implementation, the first process 120 and second process 125 can comprise devices within a perform the zero-time recovery processes described herein utilizing functions of an NVIDIA Data center On a Chip Architecture (DOCA) library. However, it should be understood that other, similar libraries and frameworks may be utilized in other implementations and are considered to be within the scope of the present disclosure.

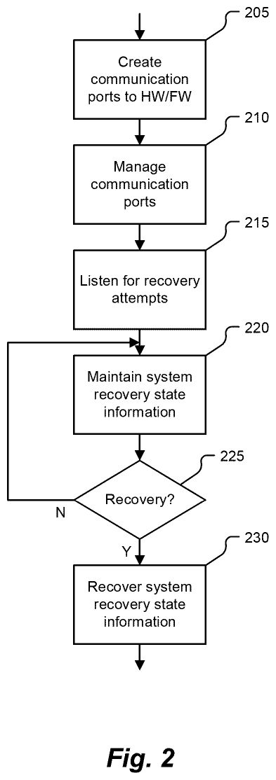

FIG. 2 is a flowchart illustrating an exemplary process for performing zero-time hardware recovery according to one embodiment of the present disclosure. As noted above, recovery of an execution process can comprise executing a first process 120. As illustrated in this example, the first process 120 can create 205 and manage 210 communication ports to hardware of the computing device 105C and listen 215 for process recovery attempts.

Also as noted above, recovery of an execution process can comprise executing a second process 125. The second process 125 can maintain 220 system recovery state information 135 in a persistent memory 130 accessible by the first process 120 and the second process 125. However, the first process can be blocked from adding changes on the recovery state managed by the second process. As noted, the system recovery state information 135 can include, but is not limited to, hardware state information for the computing device 105C. The second process 125 can determine 225 whether a recovery 225 is needed, e.g., due to a failure or an update. Upon determining 225 a recovery of the second process is needed, the second process 125 can recover 230 the system recovery state information 135 from the persistent memory 130.

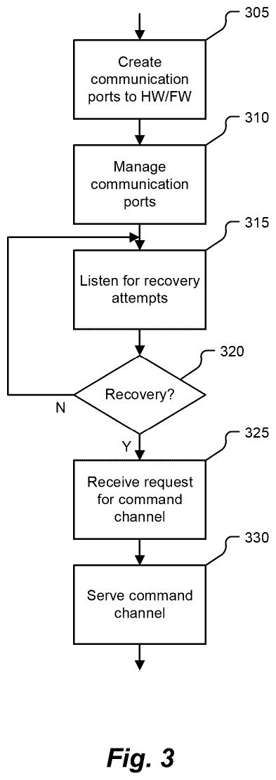

FIG. 3 is a flowchart illustrating additional details of exemplary process for performing zero-time hardware recovery according to one embodiment of the present disclosure. More specifically, this example illustrates a recovery process as may be performed by a first process 120 as described above. As illustrated in this example, the first process 120 can create 305 and manage 310 communication ports to hardware of the computing device 105C and listen 315 for process recovery attempts. It should be noted that managing 310 ports and listening 315 for recovery can be done simultaneously. A determination 320 can be made as to whether a process recovery attempt has been detected. In response to determining 320 a process recovery attempt has not been detected, the first process 120 can continue to listen 315 for a process recovery attempt.

In response to determining 320 a process recovery attempt has been detected, the first process 120 can prepare for and receive 325 a request for a command channel from the second process 125. In response, the first process 120 can serve 330 the command channel, i.e., one of the communication ports created 305 and managed 310 by the first process, to the second process 125. Thus, it should be understood that the second process also controls port management by the first process, since the second process is the orchestrator and the first process is a helper process in this embodiment. For example, the second process asks the first process to open a communication channel to local port X, and then it is imported to the second process. The command channel can then be shared between the first process 120 and the second process 125.

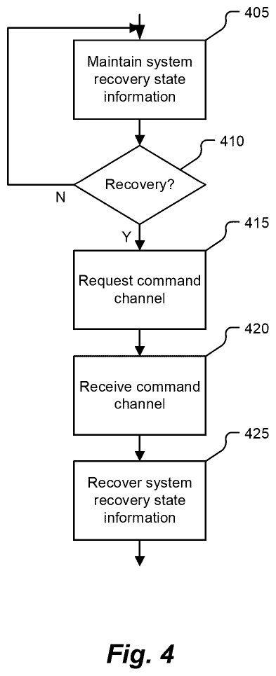

FIG. 4 is a flowchart illustrating additional details of exemplary process for performing zero-time hardware recovery according to one embodiment of the present disclosure. More specifically, this example illustrates a recovery process as may be performed by a second process 125 as described above. As illustrated in this example, the second process 125 can maintain 405 system recovery state information 135 in a persistent memory 130 accessible by the first process 120 and the second process 125. As noted, the system recovery state information 135 can include, but is not limited to, hardware state information for the computing device 105C. The second process 125 can determine 410 whether a recovery 225 is needed, e.g., due to a failure or an update. Upon determining 225 a recovery of the second process 125 is not needed, the second process 125 can continue to maintain 405 the current system recovery state information 135 in the persistent memory 130.

Upon determining 225 a recovery of the second process 125 is needed, the second process 125 can request 415 a command channel, i.e., one of the communication ports created and managed by the first process 120, from the first process 120. In response, the second process 125 can receive 420 the command channel and recover 425 the system recovery state information 135 from the persistent memory 130 using the command channel which it can share with the first process 120.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A computing device comprising:
a control circuit controlling operation of the computing device, wherein the control circuit causes the computing device to:
execute a first process, wherein the first process creates and manages communication ports to hardware of the computing device and listens for process recovery attempts, and
executes a second process, wherein the second process maintains system recovery state information in a persistent memory accessible by the first process and the second process and, upon a recovery of the second process, recovers the system recovery state information from the persistent memory.

2. The computing device of claim 1, wherein the recovery of the second process comprises a crash recovery.

3. The computing device of claim 1, wherein the recovery of the second process comprises a version update recovery.

4. The computing device of claim 1, wherein maintaining the system recovery state information comprises writing hardware state information to the persistent memory.

5. The computing device of claim 4, wherein the recovery of the second process further comprises recovery of the hardware state information from the persistent memory.

6. The computing device of claim 1, wherein the persistent memory comprises a superblock and wherein the superblock comprises metadata describing a memory structure for the system recovery state information.

7. The computing device of claim 1, wherein, upon the recovery of the second process, the second process issues an import request for a command channel to the first process.

8. The computing device of claim 7, wherein the first process serves the import request from the second process and wherein the second process then use the command channel.

9. A system comprising:
a communication network; and
a computing device coupled with the communication network, the computing device comprising a control circuit controlling operation of the computing device, wherein the control circuit causes the computing device to:
execute a first process, wherein the first process creates and manages communication ports to hardware of the computing device and listens for process recovery attempts, and
executes a second process, wherein the second process maintains system recovery state information in a persistent memory accessible to the first process and the second process and, upon a recovery of the second process, recovers the system recovery state information from the persistent memory.

10. The system of claim 9, wherein the recovery of the second process comprises a crash recovery.

11. The system of claim 9, wherein the recovery of the second process comprises a version update recovery.

12. The system of claim 9, wherein maintaining the system recovery state information comprises writing hardware state information to the persistent memory and wherein the recovery of the second process further comprises recovery of the hardware state information from the persistent memory.

13. The system of claim 9, wherein the persistent memory comprises a superblock and wherein the superblock comprises metadata describing a memory structure for the system recovery state information.

14. The system of claim 9, wherein, upon the recovery of the second process, the second process issues an import request for a command channel to the first process, wherein the first process serves the import request from the second process, and wherein the second process then use the command channel.

15. The system of claim 9, wherein the second process comprises a plurality of second processes and wherein each of the plurality of second processes maintains system recovery state information in the persistent memory and, upon recovery, recovers the system recovery state information from the persistent memory.

16. A method for recovery of an execution process, the method comprising:
executing, by a control circuit of a computing device, a first process, wherein the first process creates and manages communication ports to hardware of the computing device and listens for process recovery attempts, and
executing, by the control circuit of the computing device, a second process, wherein the second process maintains system recovery state information in a persistent memory accessible by the first process and the second process and, upon a recovery of the second process, recovers the system recovery state information from the persistent memory.

17. The method of claim 16, wherein the recovery of the second process comprises a crash recovery.

18. The method of claim 16, wherein the recovery of the second process comprises a version update recovery.

19. The method of claim 16, wherein maintaining the system recovery state information comprises writing hardware state information to the persistent memory and wherein the recovery of the second process further comprises recovery of the hardware state information from the persistent memory.

20. The method of claim 16, wherein, upon the recovery of the second process, the second process issues an import request for a command channel to the first process, wherein the first process serves the import request from the second process, and wherein the second process then use the command channel.
